(19) United States
(12) Patent Application Publication
(10) Pub. No.: US 2016/0076592 A1
(43) Pub. Date: Mar. 17, 2016

(54) SUPERCHARGER BEARING WITH GREASE RESERVOIR

(71) Applicant: Schaeffler Technologies AG & Co. KG, Herzogenaurach (DE)

(72) Inventor: Edward J. Wey, Waxhaw, NC (US)

(73) Assignee: SCHAEFFLER TECHNOLOGIES AG & CO. KG, Herzogenaurach (DE)

(21) Appl. No.: 14/804,416

(22) Filed: Jul. 21, 2015

Related U.S. Application Data
(60) Provisional application No. 62/050,957, filed on Sep. 16, 2014.

(51) Int. Cl. F16C 33/66; F16C 33/76; F16C 19/46

(52) U.S. Cl. CPC F16C 33/6618; F16C 19/463; F16C 33/76

(57) ABSTRACT

A bearing assembly, preferably for a supercharger, is provided. The bearing assembly includes an outer ring having an outer raceway and first and second axial ends. A cage having pockets is located in the outer ring, and a plurality of needles, are located in the pockets in the cage, and roll on the outer raceway of the outer ring. The needles define an inner support surface adapted to receive a shaft. A shaft seal is connected to the outer ring at the first axial end. A cap press-fit into the outer ring at the second axial end, and provides a grease reservoir.

### INCORPORATION BY REFERENCE

The following documents are incorporated herein by reference as if fully set forth: U.S. Provisional Application No. 62/050,957, filed Sep. 16, 2014.

### FIELD OF INVENTION

The present invention relates to needle roller bearings, and more particularly to bearings for superchargers.

### BACKGROUND

A supercharger is a compressor that increases the pressure or density of air supplied to an internal combustion engine. The higher air pressure provides more oxygen through the intake manifold to each cylinder during the intake cycle, increasing power output due to more fuel being burned as well as more complete combustion. Power for the supercharger is typically provided by a belt, gear, shaft, or chain connected to the crankshaft, which in turn rotates twin screws for Lysholm type superchargers or intermeshing lobes for a Roots type supercharger. Other types of blades, scrolls, or rotors can be used with either a single or two shaft supercharger arrangement in order to compress the air drawn in by the supercharger, and for the sake of convenience, these are commonly referred to herein as “rotors”. FIG. 1 shows a portion of a prior art supercharger 10, having a housing 12 in which blind holes 14 are provided for the supercharger shaft end bearings 16. Shafts 18 are supported with their axial ends in the bearings 16. The opposite side with the connection to the crankshaft drive is not shown. The rotors 20 (in this case, twin screws) are shown on the shafts 18. The shaft(s) 18 that support the rotor(s) 20 rotate at 15,000 to 20,000 rpm, and are typically supported by needle roller bearings 16. Given the high shaft speed, the bearings 16 are precision ground to very precise tolerances. The end bearing 16 for each shaft 18 is typically pressed into the respective blind hole 14 in the supercharger housing.

The known supercharger bearings have a limited life due to the high operating speed of the shaft and in part due to the geometric constraints on the volume of grease that can be packed into the bearing prior to installation. Additionally, there is no seal at the back of the blind hole, which allows the grease to work out of the bearing once the supercharger is placed into use. Finally, there is nothing to prevent contaminants, such as fine metal shavings that sometimes result from pressing the bearing into the housing, from entering the bearing through the open end.

It would be desirable to provide a supercharger shaft bearing that addresses these issues so that the bearing life can be extended.

### SUMMARY

Briefly stated, a bearing assembly, preferably for a supercharger, is provided. The bearing assembly includes an outer ring having an outer raceway and first and second axial ends. Preferably, a cage having pockets is located in the outer ring. A plurality of needles, preferably located in the pockets in the cage, roll on the outer raceway of the outer ring. The needles define an inner support surface adapted to receive a shaft. A shaft seal is connected to the outer ring at the first axial end. A cap is press-fit into the outer ring at the second axial end.

Preferably, a pre-determined measure of lubricant such as bearing grease is located with the outer ring and the cap. This is preferably injected or inserted in the bearing after it is assembled, and prior to installation in a supercharger housing so that a predetermined quantity of grease is provided.

In one preferred arrangement, the cap is a deep drawn cup. The cap forms a part of a lubricant reservoir, and also protects the second axial end of the bearing from the entry of contaminants.

In another aspect, a supercharger is provided having a housing with at least one blind hole adapted to receive a bearing. A bearing assembly as noted above is pressed into the blind hole. At least one shaft with a screw, lobe, or rotor is provided, and a first end of the shaft rotatably supported on the inner support surface defined by the needles. The shaft seal contacts the shaft to provide a lubricant reservoir defined between the shaft, the cap, the outer ring and the shaft seal.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a cross-sectional view through a supercharger housing showing a prior art bearing and shaft arrangement.

FIG. 2 is a cross-sectional view of the present supercharger bearing.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft or rotating part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Referring to FIG. 2, a bearing assembly 30 for a supercharger 10 is shown. The bearing assembly 30 includes an outer ring 32 having an outer raceway 34 and first and second axial ends 36, 38. The outer ring 32 is preferably made from bearing steel and is preferably machined, hardened, and ground. A plurality of needles 40 roll on the outer raceway 34 of the outer ring 32. The needles 40 define an inner support surface adapted to receive the shaft 18 of the supercharger. Preferably, the needles 40 are spaced apart via a cage 48 having pockets 50 located within the outer ring 32. Here, the needles 40 are preferably located in some or all of the pockets 50 in the cage 48. Alternatively, the cage can be omitted and the needles held in place prior to installation of the shaft 18 via grease packed in the outer ring 32. A shaft seal 42 is connected to the outer ring 32 at the first axial end 36. This is preferably an annular wiper seal formed of an elastomer and may include a coating such as PTFE. The shaft seal 42 is preferably held in a recess 41 formed in the outer ring 32 at the first axial end 36.

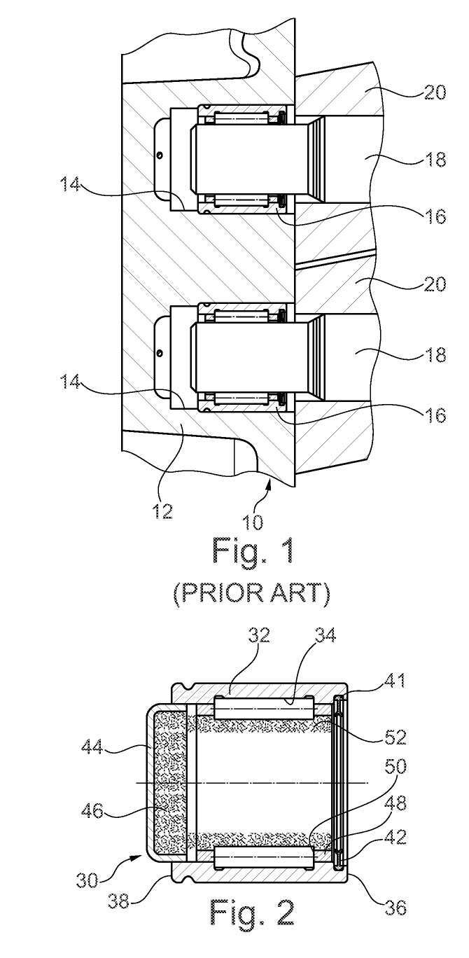

Still with reference to FIG. 2, a cap 44 is press fit into the outer ring 32 at the second axial end 38. The cap 44 is preferably a deep drawn cup formed from sheet metal having an outer diameter adapted to be pressed with an interference fit inside the inner diameter of the outer ring 32 at the second axial end 38. This cap 44 forms a part of a lubricant reservoir 46 which allows the bearing assembly 30 to be pre-charged with a pre-determined measure of lubricant 52 indicated with dotted markings. The lubricant 52 is preferably a high temperature bearing grease and this can be pre-charged into the bearing assembly 30 at the time of assembly so that it is already present in the desired quantity when the bearing assembly 30 is pressed into the supercharger housing 12. Preferably, the bearing assembly 30 has an outer envelope that is similar to the prior known bearing 16 so that it can be a preferred replacement without the need for changing the shape or size of the supercharger housing 12 shown in FIG. 1 as typically the blind holes 14 include an additional open space beyond the second axial end 38 of the bearing which can receive the cap 44. Once pressed into the hole 14, the bearing assembly 30 receives and rotatably supports a first end of the shaft 18 on the inner support surface thereof defined by the needles 40. The shaft seal 42 contacts the outside diameter of the shaft 18 to provide a sealed lubricant reservoir 46 between the shaft 18, the cap 44, the outer ring 32, and the shaft seal 42. The cap 44 provides the benefit of an increase in the captive volume of grease or lubricant in the bearing 30 for improved surface life while at the same time preventing the grease in the bearing from being expelled into the open area at the end of the blind bore 14 during supercharger operation. Further, the cap 44 seals the second axial end 38 of the bearing assembly 30 which prevents contamination from entering the bearing assembly 30 during supercharger assembly, such as small metal shavings created by pressing the bearing assembly 30 into the housing 12. The cap 44 is preferably sized to fit within the existing supercharger housing 12 so that the bearing assembly 30 can be provided as a preferred replacement part once the original supercharger bearing(s) 16 require replacement or can be provided as an OEM supercharger bearing that provides for improved supercharger bearing life.

Having thus described the preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A bearing assembly, comprising:
an outer ring having an outer raceway and first and second axial ends;
a plurality of needles roll on the outer raceway of the outer ring, the needles defining an inner support surface adapted to receive a shaft;
a shaft seal connected to the outer ring at the first axial end; and
a cap press-fit into the outer ring at the second axial end.

2. The bearing assembly of claim 1, further comprising a pre-determined measure of lubricant located with the outer ring and the cap.

3. The bearing assembly of claim 1, wherein the cap is a deep drawn cup.

4. The bearing assembly of claim 1, wherein the cap forms a part of a lubricant reservoir.

5. The bearing assembly of claim 1, further comprising a cage having pockets located within the outer ring, and the needles are located in the pockets in the cage.

6. A supercharger comprising:
a housing having at least one blind hole adapted to receive a bearing;
a bearing assembly pressed into the blind hole, the bearing assembly including an outer ring having an outer raceway and first and second axial ends, a cage having pockets, a plurality of needles located in the pockets in the cage that roll on the outer raceway of the outer ring, the needles defining an inner support surface adapted to receive a shaft, a shaft seal connected to the outer ring at the first axial end, and a cap press-fit into the outer ring at the second axial end;
at least one shaft with a rotor, a first end of the shaft rotatably supported on the inner support surface defined by the needles, and the shaft seal contacting the shaft to provide a lubricant reservoir defined between the shaft, the cap, the outer ring and the shaft seal.

7. The supercharger of claim 6, further comprising a pre-determined measure of lubricant located with the outer ring and the cap.

8. The supercharger of claim 6, wherein the cap is a deep drawn cup.
